(19) United States
(12) Patent Application Publication
(10) Pub. No.: US 2023/0096701 A1
(43) Pub. Date: Mar. 30, 2023

(54) ERGONOMIC RABBIT VIBRATOR

(71) Applicant: Queen City Boxes, Inc. dba Unbound Inc., New York, NY (US)

(72) Inventors: Latika Sridhar, Brooklyn, NY (US); Pauline Claire Rodriguez, New York, NY (US); Katherine Rockett, Brooklyn, NY (US); Sarah Kinney, Yulan, NY (US); Wu Chenfeng, Shenzhen (CN)

(21) Appl. No.: 17/845,735

(22) Filed: Jun. 21, 2022

Related U.S. Application Data
(60) Provisional application No. 63/247,844, filed on Sep. 24, 2021.

(51) Int. Cl. A61H 19/00; A61H 23/02

(52) U.S. Cl. CPC A61H 19/44; A61H 19/34; A61H 23/0218; A61H 2201/0153

(57) ABSTRACT

A rabbit vibrator comprising two arms connected to an ergonomic handle. The rabbit vibrator consists of an internal arm that stimulates the vagina and external arm that stimulates the clitoris, both integrated into a triangular handle. The body of the product is super flexible, made of compliant silicone for the user's comfort and conformation to their anatomy.

### CROSS-REFERENCE TO RELATED APPLICATION

This application claims priority to and is a non-provisional of U.S. Patent Application No. 63/247,844, filed Sep. 24, 2021, and entitled “ERGONOMIC RABBIT VIBRATOR,” the disclosure of which is incorporated by reference herein in its entirety for all purposes.

### BACKGROUND

This disclosure generally relates to personal massage devices or vibrators and more particularly to a vibrator with an ergonomic handle for gripping and positioning.

Vibrators come in a variety of configurations and perform a variety of functions ranging from medical therapy to erotic stimulation. Vibrators are generally held or positioned by the user while in use. However, movement of these vibrators is fairly limited and is not designed specifically to accommodate the different physiologies of many different users while stimulating more than one area of the body simultaneously and providing independent user control of the stimulation. Previous vibrators are cumbersome to move and position while in use which can lead to wrist fatigue.

### BRIEF SUMMARY OF THE INVENTION

Various embodiments of the present invention are directed to an ergonomic rabbit vibrator that is shaped to conform to the user's anatomy and be comfortable to grip and use either by the user or a partner. The vibrator generally includes at least to arms extending from a handle. The handle is configured to have a plurality of gripping portions. The plurality gripping portions extend at an angle offset from the longitudinal axis of the vibrator. The gripping portions are configured to be easy to for the user to grip and to combat wrist fatigue.

According to various embodiments of the vibrator, the vibrator or personal pleasure device comprises a handle having an opening, an external arm directly connected to a first portion of the handle, and an internal arm directly connected to a second portion of the handle. The external arm is configured to stimulate a first portion of a user and the internal arm is configured to stimulate a second portion of the user. The vibrator includes at least one motion mechanism configured to oscillate at least a portion of the device.

According to other various embodiments of the vibrator, the vibrator comprises a handle, an internal arm having a proximal end and a distal end, and an external arm having a proximal end and a distal end. The proximal ends of the internal arm and external arm are attached to the handle. The distal end of the external arm is closer to the internal arm than the proximal end of the external arm.

According to other various embodiments of the vibrator, the vibrator comprises a handle portion and an arm portion, wherein the arm portion is configured to contact the vagina or clitoris of a user. The arm portion has a longitudinal axis. The handle portion includes at least a first gripping portion having a lengthwise direction and a second gripping portion having a lengthwise direction. The lengthwise direction of the first gripping portion is offset from the longitudinal axis of the arm by at least 5°. The lengthwise direction of the second gripping portion is offset from the longitudinal axis of the arm by at least 90°.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a perspective view of an ergonomic rabbit vibrator according to an example embodiment of the invention.

FIG. 2 is a side view of the vibrator of FIG. 1.

FIGS. 3A-C are side views of the vibrator of FIG. 1.

FIG. 4A is a front, cross-sectional view of the vibrator of FIG. 1.

FIG. 4B is a bottom, cross-sectional view of the vibrator of FIG. 1.

FIG. 5 is a back view of the vibrator of FIG. 1.

FIG. 6 is a side, cross-sectional view of the vibrator of FIG. 1.

FIG. 7A is an exploded, side view of the tube and shuttle of an example motion mechanism.

FIG. 7B is a top view of the tube of FIG. 7A.

FIG. 7C is a side view of the tube of FIG. 7B.

FIG. 8 is a front view of the vibrator of FIG. 8.

FIG. 9 shows an example flexible connector of the vibrator.

FIGS. 10A-C are side views of the vibrator of FIG. 1 with the external arm in a series of positions.

The techniques described herein can be implemented in a number of ways. Example implementations are provided below with reference to the following figures.

### DETAILED DESCRIPTION

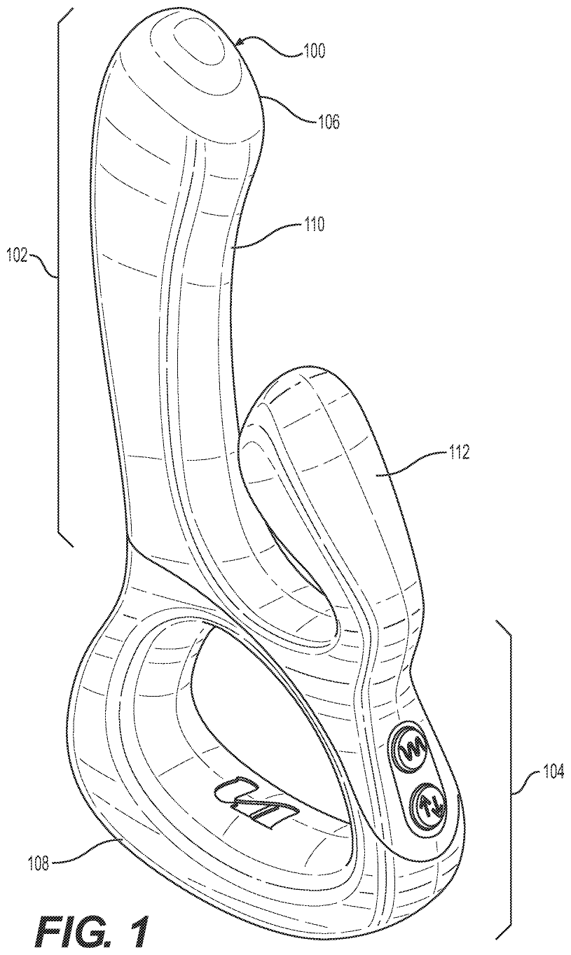

FIG. 1 illustrates an example personal pleasure device also known as an ergonomic rabbit vibrator 100. The vibrator 100 generally includes an arm portion 102 and a handle or gripping portion 104. In some examples, the arm portion 102 is oriented toward a first end 106 of the vibrator and the handle portion 104 is oriented toward a second end 108 of the vibrator. The arm portion 102 can include two arms, an internal arm 110 and an external arm 112. The internal arm 110 is generally configured to be inserted into the vagina of the user and stimulate an internal portion of the anatomy of the user. The external arm 112 is generally configured to stimulate an external portion of the anatomy of the user such as the clitoris. In some examples, the vibrator 100 includes only an internal arm 110. In other examples, the vibrator 100 includes on an external arm 112.

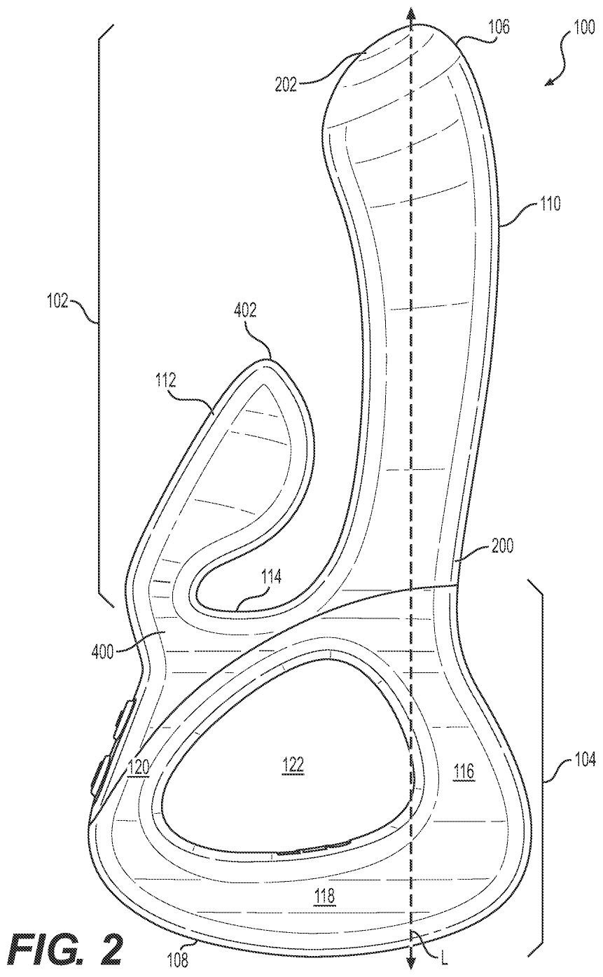

As shown in FIG. 2, in some examples, the vibrator 100 includes both an internal arm 110 and an external arm 112, and both the internal arm and external arm extend from the handle portion 104 such that the external arm does not extend directly from the internal arm. In the vibrator of FIG. 2, there is a gap 114 between the proximal end of the internal arm 110 and the proximal end of the external arm 112. With the vibrator oriented as shown in FIG. 2, with the first end 106 of the vibrator being its top and the second end 108 of the vibrator being its bottom, the connecting point for the external arm 110 is laterally offset from the connecting point of the internal arm in an X-axis. In other examples, the external arm 112 can extend directly from the internal arm 110.

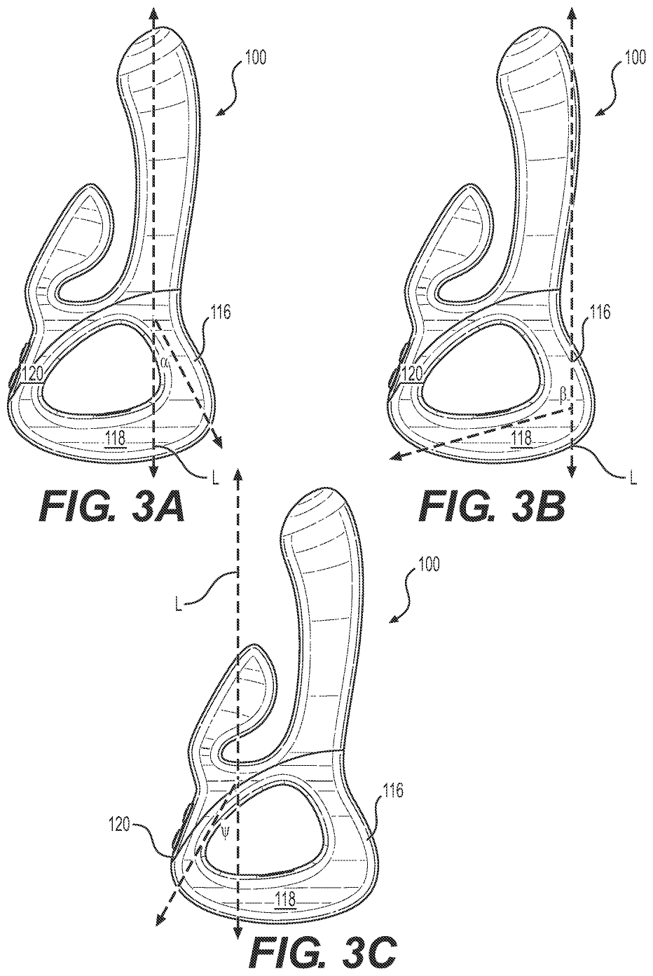

In some examples, the handle portion 104 includes one or more gripping portions 116, 118, 120. The gripping portions 116, 118, 120, each have a lengthwise direction that is generally at an angle offset from the longitudinal axis L of the vibrator 110. The longitudinal axis L of the vibrator 100 is generally parallel to the longest portion of the device. In some examples, the longitudinal axis L of the vibrator 100 is generally the same as the lengthwise direction of the internal arm 110. As shown in FIGS. 3A-C, in some examples, each gripping portion 116, 118, 120 is offset from the longitudinal axis L at a different angle α, β, φ. In some examples, the handle portion 104 of the vibrator 100 includes a first gripping portion 116. The first gripping portion 116 bends away from the longitudinal axis L of the vibrator 100 to form an angle α. In some examples, the angle α is between the longitudinal axis L and the first gripping portion 116 is between about 5° and about 90°. In other examples, the angle α between the longitudinal axis L and the first gripping portion 116 is between about 15° and about 75°. In other examples, the angle α between the longitudinal axis L and the first gripping portion 116 is between about 30° and about 50°.

In some examples, the handle portion 104 of the vibrator 100 includes a second gripping portion 118. While referred to in this application as the “second” gripping portion, example vibrators 100 can include a gripping portion configured like the second gripping portion 118 and not include a first or third gripping portion. The second gripping portion 118 bends away from the longitudinal axis L of the vibrator 100 to form an angle β. In some examples, the angle β between the longitudinal axis L and the second gripping portion 118 is between about 90° and about 180°. In other examples, the angle β between the longitudinal axis L and the second gripping portion 118 is between about 105° and about 165°. In other examples, the angle β between the longitudinal axis L and the second gripping portion 118 is between about 120° and about 140°.

In some examples, the handle portion 104 of the vibrator 100 includes a third gripping portion 120. While referred to in this application as the “third” gripping portion, example vibrators 100 can include a gripping portion configured like the third gripping portion 120 and not include a first or second gripping portion. The third gripping portion 120 bends away from the longitudinal axis L of the vibrator 100 to form an angle φ. In some examples, the angle φ between the longitudinal axis L and the first gripping portion 118 is between about 5° and about 90°. In other examples, the angle φ between the longitudinal axis L and the third gripping portion 120 is between about 15° and about 75°. In other examples, the angle β between the longitudinal axis L and the third gripping portion 118 is between about 30° and about 50°.

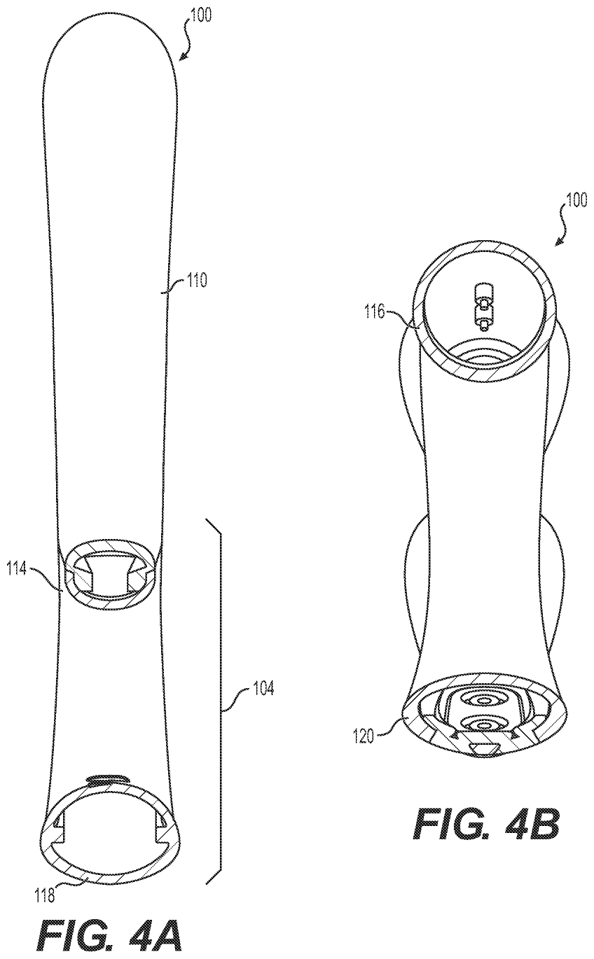

As shown in FIGS. 4A and 4B, the gripping portions 116, 118, 120 have a generally rounded cross-section. In some examples, the cross-sectional shape of the gripping portions can vary within one vibrator 100. For example, one gripping portion 116 can have a generally circular-shaped cross-section and other gripping portions 118, 120 can have a generally oval-shaped cross-section. In some examples, the size and cross-sectional shape of a gripping portion can vary along its length. The shape of the gripping portions are configured to ease the user in gripping and positioning the vibrator. In some examples, the gripping portions can include grooves configured to receive individual digits of the user's hand. In other examples, the gripping portions can include a surface texture or material to prevent slipping.

In some examples, the gripping portions 116, 118, 120 of the handle portion connect to form an opening 122 with a geometric shape. In some examples, the opening 122 has a triangular shape bounded by the three gripping portions 116, 118, 120. The corners of the opening 122 can be rounded. In other examples, the opening 122 can have another geometric shape depending on the number and orientation of the one or more gripping portions. For example, the opening 122 can have a circular, oval, generally square, or generally rectangular shape. In some examples, gripping portions of the vibrator are configured such that the opening 122 has a rounded-triangular shape. In such examples, the internal arm 110 can extend from a vertex of the rounded triangle and the external arm 112 can extend from a side of the rounded triangle.

In some examples, the opening 122 is not fully enclosed by the gripping portion 116, 118, 120. For example, the vibrator 100 may include the first gripping portion 116 and the second gripping portion 118, but not include the third gripping portion 120. The first and second gripping portions 116, 118 can form a generally L-shaped handle portion without an enclosed opening.

As shown in FIGS. 1 and 2, the proximal end 200 of the internal arm 100 connects to the handle portion 104 of the vibrator 100. In some examples, the internal arm 110 is attached to the handle portion 104 in a fixed position such that the internal arm is not movable relative the handle portion. In other examples, the connection between the internal arm 100 and the handle portion 104 is such that the position of internal arm 110 can be manipulated independent of the handle portion 104. For example, the connection between the internal arm 110 and the handle portion 104 can be hinged such that the angle of the internal arm relative to the handle portion 104 can be adjusted by the user. In other examples, the internal arm 110 can be rotated independent of the handle portion.

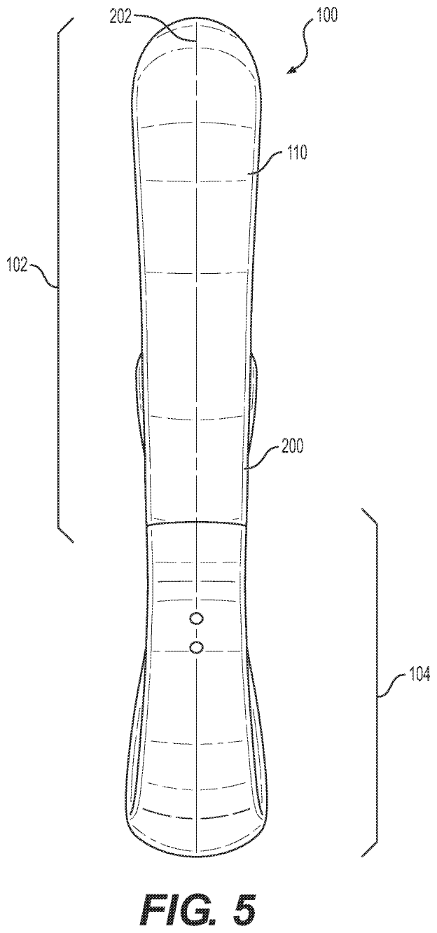

As shown in FIG. 5, in some examples, the diameter of the internal arm 110 increases along its length from the proximal end 200 to the distal end 202. In other words, the diameter of the internal arm 110 at its distal end 202 is larger the diameter of the internal arm at its proximal end 200. In other examples, the internal arm 110 can have a substantially uniform diameter. The internal arm 110 can be shaped to increase the comfort and pleasure of the user. For example, the internal arm can include ridges, textures, or other features.

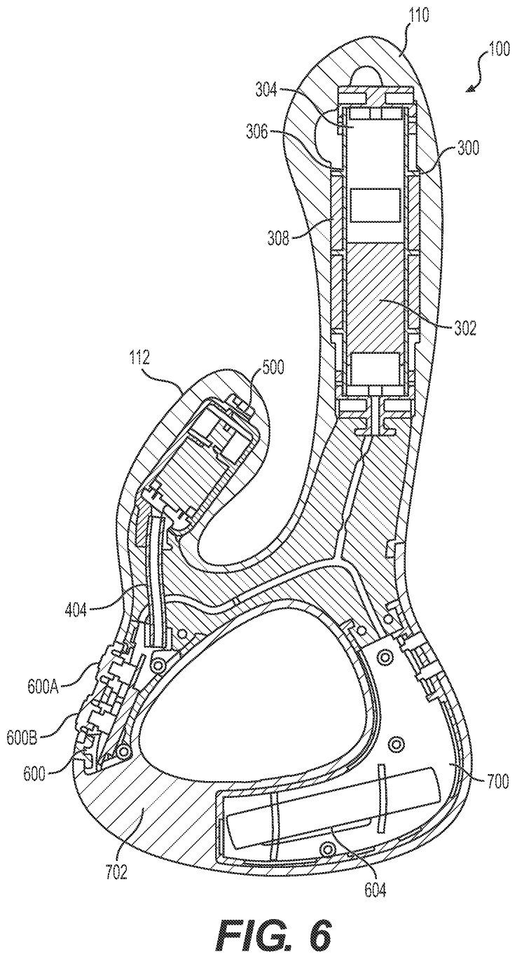

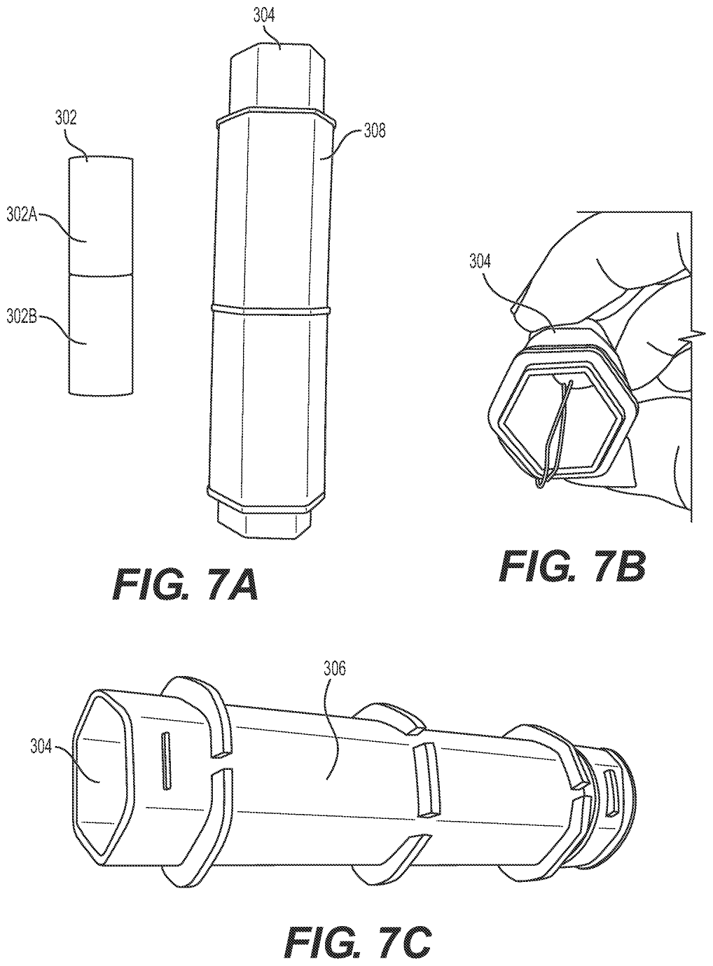

In some examples, the internal arm 110 of the vibrator 100 includes a motion mechanism 300 configured to move the internal arm in a repetitive motion, as shown in FIG. 6. In some examples, the motion mechanism 300 of the internal arm is configured to cause the internal arm to oscillate. The motion mechanism 300 can be configured to oscillate the internal arm 110 in a variety of intensities and patterns. For example, the motion mechanism 300 can be configured to cause the internal arm to vibrate, pulsate, or move in a repetitive motion. In some examples, the motion mechanism 300 includes a dynamic rumble mechanism. The motion mechanism can include a shuttle 302 contained within a tube 304. The shuttle 302 is formed from a heavy metal material. In some examples, the shuttle 302 is a unitary component. In other examples, the shuttle is formed from a series of components 302A, 302B, as shown in FIG. 7A. The shuttle 302 has sufficient mass to cause the internal arm 110 to thrust back and forth as the shuttle moves within the tube 304 as described below.

The tube has a polygonal cross-section. As shown in FIG. 7B, in some examples, the tube has a hexagonal cross-section. In other examples, the tube 304 can have any polygonal shape such as a pentagon or octagon. The tube 304 can be formed a rigid material such as ABS plastic. In some examples, the tube 304 is formed from a material, such as nylon, which dampens the sound of the motion mechanism 300. The exterior surface 306 of the tube 304 is wrapped in a metal material 308 capable of creating a magnetic field. In some examples, the exterior surface 306 of the tube is wrapped in copper wire 308. The copper wire is coiled tightly around the exterior surface 306 of the tube 304.

A controller of the motion mechanism produces either an alternating current or a step on/off current in the metal material 308 that changes the direction of magnetic field inside the tube 302 and forces the shuttle 302 back and forth in the tube. The motion of the shuttle 302 in the tube 304 forces the internal arm to move in a back-and-forth, thrusting motion. The motion mechanism 300 can be configured to move the shuttle 302 within the tube 304 in a variety of intensities and patterns.

As shown in FIGS. 1 and 2, the proximal end 400 of the external arm 112 connects to the handle portion 104 of the vibrator 100. In some example vibrators, there is a gap 114 in the handle portion 104 between the portion of the handle portion that connects with external arm 112 and the portion of the handle portion that connects with internal arm 110. The gap 114 is created where the distal end of the 200 of the internal arm 110 is offset from the distal end 400 of the external arm 400 in a lateral direction. In other words, in some example vibrators, the external arm 112 does not connect directly to the internal arm 110 of the vibrator 100. In example vibrators 100, the external arm 112 points toward the internal arm 110 such that the distal end 402 of the external arm faces the internal arm. For example, as shown in FIG. 2, the distal end 402 of the external arm 112 is positioned closer to the internal arm 110 than the proximal end 400 of the external arm. The inward angle of the external arm 112 facilitates its contact with the anatomy of the user. In some examples, the external arm 112 is curved towards the internal arm 110.

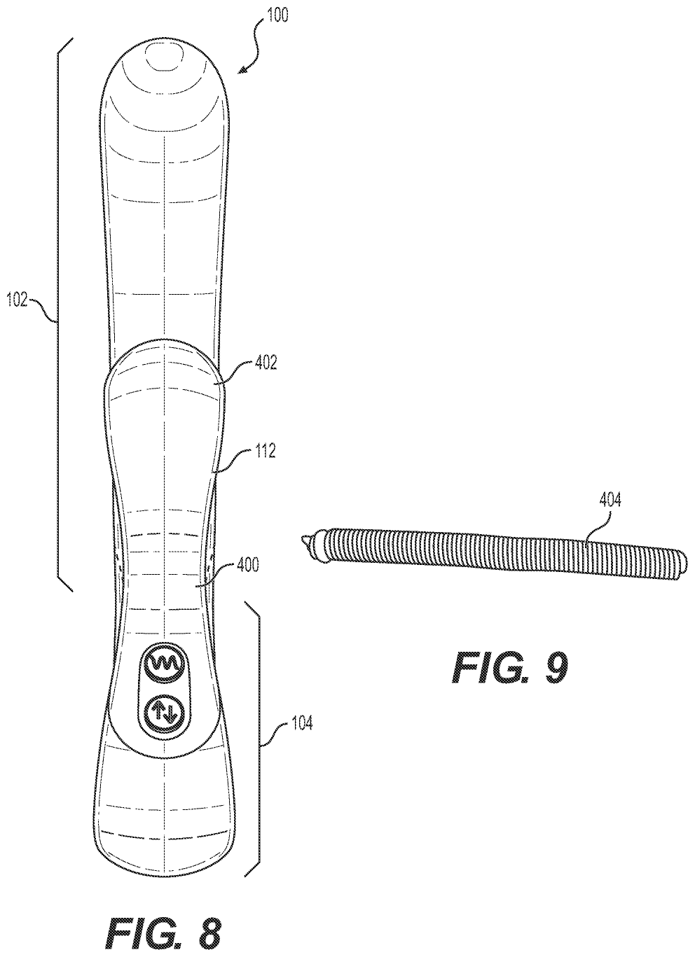

As shown in FIG. 8, in some examples, the diameter of the external arm 112 increases along its length from the proximal end 400 to the distal end 402. In other words, the diameter of the external arm 112 at its distal end 402 is larger the diameter of the internal arm at its proximal end 400. In other examples, the external arm 112 can have a substantially uniform diameter. The external arm 112 can be shaped to increase the comfort and pleasure of the user. For example, the distal end 402 or the entirety of the external arm 400 can include ridges, textures, or other features.

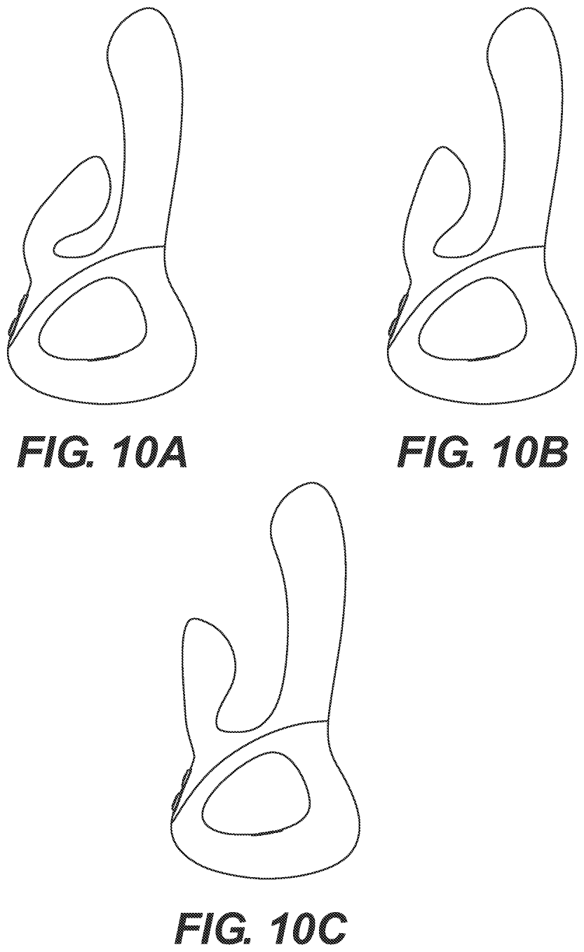

In some examples, the connection between the external arm 112 and the handle portion 104 of the vibrator 100 is hinged such that a user can change the angle of the external arm relative to the handle portion. In some examples, the external arm 112 connects to the handle portion 104 of the vibrator 100 using a flexible connector 404. The flexible connector 404 is formed from a material that is manipulable but will hold its position. Example materials of the flexible connector are metal wires. In some examples, the metal wire can be coiled as shown in FIG. 9. The flexible connector 404 allows a user to position the external arm 112 at the appropriate position for their anatomy. With a flexible connector 404, the external arm 112 of the vibrator 100 can be moved to a variety of positions, examples of which are shown in FIGS. 10A-C. The flexible connector 404 will maintain the position of the external arm 112 selected by the user.

In other examples, the connection between the external arm 112 and the handle portion 104 can be a spring. The spring will bias the external arm 112 in a position, such as that shown in FIG. 10A. The spring will allow the external arm 112 to move to the positions shown in FIGS. 10B and C, but once released, the spring will return the external arm 112 to its original position shown in FIG. 10A. In other examples, the external arm 100 of the vibrator 100 is attached to the handle portion 104 in a fixed position.

In example vibrators, the external arm 112 of the vibrator 100 includes a motion mechanism 500 configured to move the external arm in a repetitive motion. In some examples, the motion mechanism 500 of the external arm is configured to cause the external arm to oscillate. For example, the motion mechanism 500 can be configured to cause the external arm 112 to vibrate, pulsate, or move in a repetitive motion in a variety of intensities and patterns.

The rabbit vibrator 100 can include at least one button 600 used to operate a motion mechanism 300, 500 of the device. In some examples, the vibrator 100 includes a plurality of buttons. For example, the vibrator 100 can include a first button 600A configured to control the first motion mechanism 300 of the vibrator and a second button 600B configured to control the second motion device mechanism 500 of the vibrator. In other examples, the vibrator 100 can include additional buttons such as a separate power button. In other examples, the vibrator 100 can include a single button. In example vibrators 100, the buttons 600 are positioned on the front of the vibrator 100. In other examples, the buttons 600 are positioned elsewhere. In some examples, the motion mechanisms 300, 500 of the rabbit vibrator can be operated remotely using a remote or phone app. The vibrator 100 can include a battery 604 configured to power the one or more motion mechanisms 300, 500 of the device. In example vibrators 100, the battery 604 is positioned in the handle portion 104 of the device. In other examples, the battery 604 can be positioned in another part of the device. The battery 604 can be rechargeable and/or configured to be replaced.

The vibrator 100 can comprise a housing 700 at least partially surrounded by a surface material 702. The housing generally contains the motion mechanisms 300, 500, their controls, and the battery 604 of the device. In some examples, the housing can be formed from a rigid plastic such as ABS plastic. The housing 700 can also be formed from other generally rigid materials such as stainless steel or Pyrex. The surface material 702 can be formed of a deformable, body-safe material such a silicon or elastomer. In some examples, the surface material 702 covers the entire vibrator. In other examples, the surface material may only cover portions of the vibrator device 100. The surface material 702 generally covers the arm portion 102 of the vibrator. Some portions of the vibrator can consist entirely of surface material 702 rather than surface material covering the housing 700. In some examples, padding can be placed under the surface material for comfort of the user. For example, padding can be positioned around the handle opening 122 or at the distal end 202 of the internal arm. The padding can be formed from silicon pouches or another deformable component.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the examples and applications illustrated and described, and without departing from the spirit and scope of the claims.

### Example Clauses

The following paragraphs describe various examples. Any of the examples in this section may be used with any other examples in this section and/or any of the other examples or embodiments described herein.

A: In some examples, a personal pleasure device comprising a handle having an opening; an external arm directly connected to a first portion of the handle, wherein the external arm is configured to stimulate a first portion of a user; an internal arm directly connected to a second portion of the handle, wherein the internal arm is configured to stimulate a second portion of the user; and at least one motion mechanism configured to oscillate at least a portion of the device. 1

B: The personal pleasure device of example A, wherein the first portion of the handle is laterally offset from the second portion of the handle. 2

C: The personal pleasure device of example A or B, wherein the opening in the handle has a polygonal shape. 3

D: The personal pleasure device of any one of examples A-C, wherein the at least one motion mechanism comprises a metal shuttle positioned within a tube, wherein an outer surface of the tube is covered in a metal material configured to create a magnetic field that manipulates the position of the shuttle within the tube. 4

E: The personal pleasure device of example D, wherein the tube is formed from nylon. 5

F: The personal pleasure device of examples D or E, wherein the at least one motion mechanism is positioned within the internal arm. 6

G: The personal pleasure device of any of examples D-F, wherein the at least one motion mechanism is a first motion mechanism, and wherein a second motion mechanism is positioned within the external arm. 7

H: The personal pleasure device of any of examples A-G, wherein the external arm is hingedly connected to handle.

I: In some examples, a personal pleasure device comprising: a handle; an internal arm having a proximal end and a distal end, wherein the proximal end of the internal arm is attached to the handle; and an external arm having a proximal end and a distal end, wherein in the proximal end of the external arm is attached to the handle; wherein the distal end of the external arm is closer to the internal arm than the proximal end of the external arm.

J: The personal pleasure device of example I, wherein the handle includes an opening.

K: The personal pleasure device of example J, wherein the opening has a polygonal shape.

L: The personal pleasure device of any one of examples I-K, further comprising at least one motion mechanism comprises a metal shuttle positioned within a tube, wherein an outer surface of the tube is covered in a metal material configured to create a magnetic field that manipulates the position of the shuttle within the tube.

M: The personal pleasure device of example L, wherein the tube is formed from nylon.

N: The personal pleasure device of examples L or M, wherein the at least one motion mechanism is positioned within the internal arm.

O: In some examples, A personal pleasure device comprising: a handle portion and an arm portion, wherein the arm portion is configured to contact the vagina or clitoris of a user; wherein the arm portion has a longitudinal axis; wherein the handle portion includes at least a first gripping portion having a lengthwise direction and a second gripping portion having a lengthwise direction; wherein the lengthwise direction of the first gripping portion is offset from the longitudinal axis of the arm by at least 5°; and wherein the lengthwise direction of the second gripping portion is offset from the longitudinal axis of the arm by at least 90°.

P: The personal pleasure device of example O, wherein the first gripping portion and second gripping portion at least partially surround an opening in the handle portion.

Q: The personal pleasure device of example P, wherein the opening has a polygonal shape.

R: The personal pleasure device of any one of examples O-Q, wherein the arm portion comprises an external arm, wherein the external arm is configured to stimulate a first portion of a user; and an internal arm, wherein the internal arm is configured to stimulate a second portion of a user.

S: The personal pleasure device of example R, wherein the external arm is hingedly coupled to the handle portion of the device.

T: The personal pleasure device of any of examples O-R, further comprising at least one motion mechanism comprises a metal shuttle positioned within a tube, wherein an outer surface of the tube is covered in a metal material configured to create a magnetic field that manipulates the position of the shuttle within the tube.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that some examples can be used and that changes or alterations, such as structural changes, can be made. Such examples, changes or alterations are not necessarily departures from the scope with respect to the intended claimed subject matter. While features, components, and operations may be presented in a certain arrangement, configuration, and/or order, the arrangement, configuration, and/or order may be rearranged, combined, or omitted without changing the function of the systems and methods described.

What is claimed is:

1. A personal pleasure device comprising:
a handle having an opening;
an external arm directly connected to a first portion of the handle, wherein the external arm is configured to stimulate a first portion of a user;
an internal arm directly connected to a second portion of the handle, wherein the internal arm is configured to stimulate a second portion of the user; and
at least one motion mechanism configured to oscillate at least a portion of the device.

2. The personal pleasure device of claim 1, wherein the first portion of the handle is laterally offset from the second portion of the handle.

3. The personal pleasure device of claim 1, wherein the opening in the handle has a polygonal shape.

4. The personal pleasure device of claim 1, wherein the at least one motion mechanism comprises a metal shuttle positioned within a tube, wherein an outer surface of the tube is covered in a metal material configured to create a magnetic field that manipulates the position of the shuttle within the tube.

5. The personal pleasure device of claim 4, wherein the tube is formed from nylon.

6. The personal pleasure device of claim 4, wherein the at least one motion mechanism is positioned within the internal arm.

7. The personal pleasure device of claim 6, wherein the at least one motion mechanism is a first motion mechanism, and wherein a second motion mechanism is positioned within the external arm.

8. The personal pleasure device of claim 1, wherein the external arm is hingedly connected to handle.

9. A personal pleasure device comprising:
a handle;
an internal arm having a proximal end and a distal end, wherein the proximal end of the internal arm is attached to the handle; and
an external arm having a proximal end and a distal end, wherein in the proximal end of the external arm is attached to the handle; wherein the distal end of the external arm is closer to the internal arm than the proximal end of the external arm.

10. The personal pleasure device of claim 9, wherein the handle includes an opening.

11. The personal pleasure device of claim 10, wherein the opening has a polygonal shape.

12. The personal pleasure device of claim 9, further comprising at least one motion mechanism comprises a metal shuttle positioned within a tube, wherein an outer surface of the tube is covered in a metal material configured to create a magnetic field that manipulates the position of the shuttle within the tube.

13. The personal pleasure device of claim 12, wherein the tube is formed from nylon.

14. The personal pleasure device of claim 12, wherein the at least one motion mechanism is positioned within the internal arm.

15. A personal pleasure device comprising:
a handle portion and an arm portion, wherein the arm portion is configured to contact the vagina or clitoris of a user;
wherein the arm portion has a longitudinal axis;
wherein the handle portion includes at least a first gripping portion having a lengthwise direction and a second gripping portion having a lengthwise direction;
wherein the lengthwise direction of the first gripping portion is offset from the longitudinal axis of the arm by at least 5°; and
wherein the lengthwise direction of the second gripping portion is offset from the longitudinal axis of the arm by at least 90°.

16. The personal pleasure device of claim 15, wherein the first gripping portion and second gripping portion at least partially surround an opening in the handle portion.

17. The personal pleasure device of claim 16, wherein the opening has a polygonal shape.

18. The personal pleasure device of claim 15, wherein the arm portion comprises:
an external arm, wherein the external arm is configured to stimulate a first portion of a user; and
an internal arm, wherein the internal arm is configured to stimulate a second portion of the user.

19. The personal pleasure device of claim 18, wherein the external arm is hingedly coupled to the handle portion of the device.

20. The personal pleasure device of claim 15, further comprising at least one motion mechanism comprises a metal shuttle positioned within a tube, wherein an outer surface of the tube is covered in a metal material configured to create a magnetic field that manipulates the position of the shuttle within the tube.
